(19) United States
(12) Patent Application Publication
(10) Pub. No.: US 2012/0267566 A1
(43) Pub. Date: Oct. 25, 2012

(54) LITHIUM ION SECONDARY BATTERY POSITIVE ELECTRODE MATERIAL

(76) Inventors: Tomohiro Nagakane, Otsu-shi (JP); Ken Yuki, Otsu-shi (JP); Akihiko Sakamoto, Otsu-shi (JP); Tetsuo Sakai, Ikeda-shi (JP); Meijing Zou, Ikeda-shi (JP)

(21) Appl. No.: 13/502,423

(22) PCT Filed: Oct. 18, 2010
(86) PCT No.: PCT/JP2010/068254

§ 371 Date: Jul. 13, 2012

(30) Foreign Application Priority Data
Oct. 19, 2009 (JP) 2009-240603
Feb. 9, 2010 (JP) 2010-026319

(51) Int. Cl. H01M 4/58

(52) U.S. Cl. 252/182.1

(57) ABSTRACT

Provided is a positive electrode material for a lithium ion secondary battery, including a crystallized glass powder including an olivine-type crystal represented by General Formula LiMₓFe₁₋ₓPO₄ (0≦x<1, M represents at least one kind selected from Nb, Ti, V, Cr, Mn, Co, and Ni), in which the crystallized glass powder has an amorphous layer in its surface.

### TECHNICAL FIELD

The present invention relates to a positive electrode material for a lithium ion secondary battery used for portable electronic devices and electric vehicles, and more specifically, to a lithium iron phosphate positive electrode material, which is inexpensive and highly safe, as an alternative to conventional lithium cobaltate and lithium manganate.

### BACKGROUND ART

A lithium ion secondary battery has established its status as a high-capacity and light-weight power supply indispensable for portable electronic terminal devices and electric vehicles. Hitherto, inorganic metal oxides such as lithium cobaltate (LiCoO₂) and lithium manganate (LiMnO₂) have been used as positive electrode materials for a lithium ion secondary battery. However, to cope with increased power consumption due to enhanced performance of electronic devices in recent years, development of a lithium ion secondary battery having a higher capacity has been demanded. In addition, from the standpoints of an environmental conservation issue and an energy issue, it has been demanded to replace a material having a large environmental load, such as Co and Mn, by an environment-conscious material. Further, attention has been paid in recent years to the problem of the depletion of cobalt resources. From such standpoint as well, it has been demanded to replace lithium cobaltate and lithium manganate by an inexpensive positive electrode material.

In recent years, attention has been paid to an olivine-type crystal represented by General Formula LiMₓFe₁₋ₓPO₄ (0≦x<1, M represents at least one kind selected from Nb, Ti, V, Cr, Mn, Co, and Ni) among lithium compounds containing iron, because the olivine-type crystal is advantageous from the viewpoints of, for example, their cost and resource volume, and a variety of research and development activities have been under way (see, for example, Patent Literature 1). LiMₓFe₁₋ₓPO₄ is excellent in temperature stability as compared to LiCoO₂, and hence is expected to work safely at high temperatures. In addition, LiMₓFe₁₋ₓPO₄ has a structure having a phosphate skeleton, and hence has a feature of being excellent in resistance to structural degradation due to a charge-discharge reaction.

### CITATION LIST

### Patent Literature

Patent Literature 1: JP 09-134725 A

### SUMMARY OF INVENTION

### Technical Problems

A lithium ion secondary battery using a conventional positive electrode material including an olivine-type LiMₓFe₁₋ₓPO₄ crystal has had a problem in that, when a large electric current flows at the time of discharge, the internal resistance of the battery becomes higher, leading to a reduction in output voltage. This is probably because lithium ion conductivity and electron conductivity are low at the interface between the positive electrode material and an electrolyte existing around the positive electrode material, with the result that internal resistance is liable to occur.

Further, the lithium ion secondary battery using a conventional positive electrode material including an olivine-type LiMₓFe₁₋ₓPO₄ crystal also has had a problem in that, as a result of repeating charge and discharge, a dendrite (dendritic crystal) is produced in its electrolytic solution, leading to the occurrence of a short circuit in the battery.

An object of the present invention is to provide a positive electrode material used for producing a lithium ion secondary battery in which a reduction in output voltage is small even when a large electric current flows at the time of discharge.

Another object of the present invention is to provide a positive electrode material used for producing a lithium ion secondary battery which is excellent in long-term reliability because no short circuit attributed to the repetition of charge and discharge occurs when the positive electrode material is used in the lithium ion secondary battery.

### Solutions to Problems

The inventors of the present invention have made intensive studies, and have consequently found that, in a positive electrode material for a lithium ion secondary battery, including a crystallized glass powder including a precipitated olivine-type LiMₓFe₁₋ₓPO₄ crystal, the surface modification of the crystallized glass powder provides a positive electrode material which is excellent in lithium ion conductivity and electron conductivity. The finding is proposed as the present invention.

That is, the present invention relates to a positive electrode material for a lithium ion secondary battery, including a crystallized glass powder including an olivine-type crystal represented by General Formula LiMₓFe₁₋ₓPO₄ where a relationship of 0≦x<1 is established and M represents at least one kind selected from Nb, Ti, V, Cr, Mn, Co, and Ni, in which the crystallized glass powder has an amorphous layer in its surface.

As previously described, there has been a problem in that the lithium ion conductivity and electron conductivity are low at the interface between a positive electrode material and an electrolyte in a lithium ion secondary battery, with the result that internal resistance is liable to occur. In view of the foregoing, it has become possible to improve the lithium ion conductivity and electron conductivity at the interface between a positive electrode material and an electrolyte by adopting a configuration in which the crystallized glass powder forming the positive electrode material has an amorphous layer in its surface. As a result, the elevation of the internal resistance of the battery can be suppressed even when a large electric current flows at the time of discharge, thus being able to suppress the reduction in output voltage of the battery.

Second, in the positive electrode material for a lithium ion secondary battery of the present invention, it is preferred that the crystallized glass powder include, as a composition expressed in terms of mol %, 20 to 50% of Li₂O, 5 to 40% of Fe₂O₃, and 20 to 50% of P₂O₅.

According to the configuration, the crystallized glass including an olivine-type crystal represented by General Formula LiMₓFe₁₋ₓPO₄ is more likely to be provided.

Third, in the positive electrode material for a lithium ion secondary battery of the present invention, it is preferred that the crystallized glass powder further include, as a composition expressed in terms of mol %, 0.1 to 25% of Nb₂O₅+V₂O₅+SiO₂+B₂O₃+GeO₂+Al₂O₃+Ga₂O₃+Sb₂O₃+Bi₂O₃.

When the crystallized glass powder further includes these components, the glass-forming ability of the positive electrode material improves and homogeneous glass is more likely to be provided.

Fourth, in the positive electrode material for a lithium ion secondary battery of the present invention, it is preferred that the amorphous layer include, as a composition expressed in terms of atom %, 5 to 40% of P, 0 to 25% of Fe+Nb+Ti+V+Cr+Mn+Co+Ni, 0 to 60% of C, and 30 to 80% of O.

When the amorphous layer includes the composition, excellent properties in both the lithium ion conductivity and the electron conductivity are exhibited, and the resistance at the interface between the positive electrode material and an electrolyte is more likely to be reduced.

Fifth, in the positive electrode material for a lithium ion secondary battery of the present invention, it is preferred that the crystallized glass powder have an average particle diameter of 0.01 to 20 μm.

According to the configuration, the whole surface area of the positive electrode material becomes smaller, and consequently, exchanges of lithium ions and electrons are more likely to be performed, leading to providing a sufficient discharge capacity more easily.

Sixth, in the positive electrode material for a lithium ion secondary battery of the present invention, it is preferred that the positive electrode material has an average output voltage of 2.5 V or more at the time of discharge at a 10 C rate.

Seventh, in the positive electrode material for a lithium ion secondary battery of the present invention, it is preferred that the positive electrode material has a discharge capacity of 15 mAhg⁻¹ or more at a 10 C rate.

Eighth, according to the present invention, in a lithium ion secondary battery of the present invention using any of the positive electrode materials for a lithium ion secondary battery, a reduction in output voltage is small even when a large electric current flows at the time of discharge.

Further, the inventors of the present invention have studied to solve the problem. As a result, the inventors have discovered that the production of a dendrite in an electrolytic solution due to repeated charge and discharge is caused by a magnetic particle contained as an impurity in a positive electrode material including an olivine-type LiMₓFe₁₋ₓPO₄ crystal. Then, the inventors have found that it is possible to suppress, by controlling the content of the magnetic particle in the positive electrode material, the production of a dendrite due to repeated charge and discharge and the occurrence of a short circuit caused by the dendrite. The finding is proposed as the present invention.

That is, the present invention relates to a positive electrode material for a lithium ion secondary battery, including an olivine-type crystal represented by General Formula LiMₓFe₁₋ₓPO₄ where a relationship of 0≦x<1 is established and M represents at least one kind selected from Nb, Ti, V, Cr, Mn, Co, and Ni, in which the positive electrode material includes a magnetic particle at 1,000 ppm or less.

A positive electrode material including an olivine-type LiMₓFe₁₋ₓPO₄ crystal is usually produced by a solid phase reaction method, in which a lithium raw material such as lithium carbonate, an iron raw material such as iron oxalate or metal iron, a phosphate raw material such as ammonium hydrogen phosphate, and the like are mixed, and the mixture is fired at 500 to 900° C. under an inert or reductive atmosphere. Simultaneously with the production process or after the production process, carbon or an organic compound is mixed in the mixture, followed by firing, thereby imparting electron conductivity to the positive electrode material.

However, it has been found that, when an unreacted iron raw material remains at the time of production by the solid phase reaction method, the iron raw material is reduced to produce a magnetic particle of, for example, metal iron and iron phosphide in firing a mixture of carbon or an organic compound. When the magnetic particle exists in a positive electrode material, the magnetic particle is dissolved in an electrolytic solution to produce a dendrite in charging and discharging a battery produced by using the positive electrode material, resulting in causing a short circuit in the battery.

Based on the finding described above, the content of a magnetic particle is restricted to 1,000 ppm or less in the positive electrode material of the present invention, and hence a dendrite is not easily produced even when charge and discharge are repeated, and the occurrence of a short circuit caused by the dendrite can be suppressed to the greatest possible extent.

It is preferred that the positive electrode material for a lithium ion secondary battery of the present invention include a crystallized glass including, as a composition expressed in terms of mol %, 20 to 50% of Li₂O, 5 to 40% of Fe₂O₃, and 20 to 50% of P₂O₅.

The positive electrode material includes the crystallized glass having the composition, and hence the content of a magnetic particle can be reduced. This is because crystallized glass is produced through a glass melting process unlike conventional solid phase reaction products, and hence an unreacted iron raw material causing the production of a magnetic particle is difficult to remain.

It is preferred that the positive electrode material for a lithium ion secondary battery of the present invention further include, as a composition expressed in terms of mol %, 0.1 to 25% of Nb₂O₅+V₂O₅+SiO₂+B₂O₃+GeO₂+Al₂O₃+Ga₂O₃+Sb₂O₃+Bi₂O₃.

In the positive electrode material for a lithium ion secondary battery of the present invention, it is preferred that the positive electrode material has a discharge capacity of 15 mAhg⁻¹ or more at a 10 C rate.

In the positive electrode material for a lithium ion secondary battery of the present invention, it is preferred that the positive electrode material has an average output voltage of 2.5 V or more at a time of discharge at a 10 C rate.

The lithium ion secondary battery of the present invention using any of the positive electrode materials for a lithium ion secondary battery is excellent in long-term reliability because no short circuit attributed to the repetition of charge and discharge occurs.

### DESCRIPTION OF EMBODIMENTS

A positive electrode material for a lithium ion secondary battery according to a first embodiment of the present invention includes a crystallized glass powder including an olivine-type crystal represented by General Formula LiMₓFe₁₋ₓPO₄ (0≦x<1, M represents at least one kind selected from Nb, Ti, V, Cr, Mn, Co, and Ni). The crystallized glass powder preferably includes, as a composition expressed in terms of mol %, 20 to 50% of Li₂O, 5 to 40% of Fe₂O₃, and 20 to 50% of P₂O₅. The reason why the composition was limited to that mentioned above is described below.

Li₂O is a main component of an LiMₓFe₁₋ₓPO₄ crystal. The content of Li₂O is 20 to 50%, preferably 25 to 45%. When the content of Li₂O is less than 20% or more than 50%, the LiMₓFe₁₋ₓPO₄ crystal is difficult to precipitate.

Fe₂O₃ is also a main component of an LiMₓFe₁₋ₓPO₄ crystal. The content of Fe₂O₃ is preferably 10 to 40%, 15 to 35%, 25 to 35%, particularly preferably 31.6 to 34%. When the content of Fe₂O₃ is less than 10%, the LiMₓFe₁₋ₓPO₄ crystal is difficult to precipitate. When the content of Fe₂O₃ is more than 40%, the LiMₓFe₁₋ₓPO₄ crystal is difficult to precipitate and an undesirable Fe₂O₃ crystal is liable to precipitate.

P₂O₅ is also a main component of an LiMₓFe₁₋ₓPO₄ crystal. The content of P₂O₅ is 20 to 50%, preferably 25 to 45%. When the content of P₂O₅ is less than 20% or more than 50%, the LiMₓFe₁₋ₓPO₄ crystal is difficult to precipitate.

In addition to the above-mentioned components, it is permissible to add, as components for improving the glass-forming ability, for example, Nb₂O₅, V₂O₅, SiO₂, B₂O₃, GeO₂, Al₂O₃, Ga₂O₃, Sb₂O₃, and Bi₂O₃. The total content of these components is preferably 0.1 to 25%. When the total content of these components is less than 0.1%, vitrification tends to be difficult. When the total content is more than 25%, the ratio of an LiMₓFe₁₋ₓPO₄ crystal may lower.

Of those, Nb₂O₅ is a component effective for providing homogeneous glass and contributes to forming an amorphous layer easily in the surface of crystallized glass. The content of Nb₂O₅ is preferably 0.1 to 20%, 1 to 10%, particularly preferably 4 to 6.3%. When the content of Nb₂O₅ is less than 0.1%, homogeneous glass is difficult to be provided. On the other hand, when the content of Nb₂O₅ is more than 20%, a different kind of crystal such as an iron niobate crystal precipitates at the time of glass crystallization, and consequently, the charge and discharge characteristics of a battery using the resultant glass tend to lower.

The content of the LiMₓFe₁₋ₓPO₄ crystal in the crystallized glass powder is preferably 20 mass % or more, 50 mass % or more, 70 mass % or more. When the content of the LiMₓFe₁₋ₓPO₄ crystal is less than 20 mass %, the discharge capacity tends to lower. Note that though the upper limit of the content is not particularly limited, the content is realistically 99 mass % or less, more realistically 95 mass % or less.

As the size of a crystallite in the LiMₓFe₁₋ₓPO₄ crystal in the crystallized glass powder is smaller, it is possible to make the particle diameter of the crystallized glass powder smaller, and hence the electric conductivity can be improved. Specifically, the size of a crystallite is preferably 100 nm or less, more preferably 80 nm or less. The lower limit of the size is not particularly limited, but the size is realistically 1 nm or more, more realistically 10 nm or more. Note that the size of a crystallite is determined according to the Scherrer's equation based on the results of the powder X-ray diffraction analysis of a crystallized glass powder.

The crystallized glass forming the positive electrode material for a lithium ion secondary battery according to the first embodiment is characterized by having an amorphous layer in its surface.

The amorphous layer preferably includes, as a composition expressed in terms of atom %, 5 to 40% of P, 0 to 25% of Fe+Nb+Ti+V+Cr+Mn+Co+Ni, 0 to 60% of C, and 30 to 80% of O. The reason why the composition was limited to that mentioned above is described below.

P is a main component for forming a phosphate structure excellent in lithium ion conductivity. The content of P is 5 to 40%, preferably 6 to 37%. When the content of P is less than 5% or more than 40%, the phosphate structure is not formed, and hence the lithium ion conductivity tends to lower.

O is also a main component for forming a phosphate structure. The content of O is 30 to 80%, preferably 40 to 70%. When the content of O is less than 30% or more than 80%, the phosphate structure is not formed, and hence the lithium ion conductivity tends to lower.

Fe, Nb, Ti, V, Cr, Mn, Co, and Ni are components for improving the electron conductivity of the amorphous layer. The total content of these components is 0 to 25%, preferably 0.1 to 20%. When the total content of these components is more than 25%, the lithium ion conductivity tends to lower.

C is also a component for improving the electron conductivity of the amorphous layer. The content of C is preferably 0 to 60%, 5 to 60%, 10 to 55%, particularly preferably 15 to 50%. When the content of C is more than 60%, the lithium ion conductivity of the amorphous layer tends to lower. Note that the content of C is preferably 5% or more in order for the electron conductivity to be imparted sufficiently.

The composition of the amorphous layer can be adjusted by appropriately selecting the composition of crystallized glass, the conditions of crystallization (a heat treatment temperature, a heat treatment time, and the like), and the addition amount of a conduction active material such as carbon or an organic compound described below.

The thickness of the amorphous layer is preferably 5 nm or more, particularly preferably 10 nm or more. When the thickness of the amorphous layer is less than 5 nm, the effect of improving the lithium ion conductivity and the electron conductivity at the interface between the crystallized glass powder and an electrolyte is not easily provided in a battery, and the output voltage of the battery is liable to lower. Further, when an aqueous paste including water as a solvent is used at the time of producing an electrode, Li ions in a crystal are eluted, with the result that the discharge capacity may lower. On the other hand, the upper limit of the thickness of the amorphous layer is not particularly limited, but when the thickness is too large, the transfer of lithium ions and electrons at the interface between the crystallized glass powder and an electrolyte is blocked to the worse in a battery, and the output voltage may lower. From the viewpoint described above, the thickness of the amorphous layer is 50 nm or less, preferably 40 nm or less.

The ratio of the amorphous layer in the surface of the crystallized glass powder is preferably 40% or more, 45% or more, particularly preferably 50% or more. When the ratio of the amorphous layer is less than 40%, the effect of improving the lithium ion conductivity and the electron conductivity at the interface between the crystallized glass powder and an electrolyte is not easily provided in a battery, and the output voltage of the battery is liable to lower.

Note that the thickness of the amorphous layer and the ratio of the amorphous layer in the surface of the crystallized glass powder can be adjusted by appropriately selecting the conditions of crystallization (a heat treatment temperature, a heat treatment time, and the like) and the addition amount of a conduction active material such as carbon or an organic compound described below.

The average particle diameter (D₅₀) of the crystallized glass powder is 0.01 to 20 μm, preferably 0.1 to 15 μm, more preferably 0.5 to 10 μm. When the average particle diameter of the crystallized glass powder is more than 20 μm, the whole surface area of the resultant positive electrode material becomes smaller, exchanges of lithium ions and electrons are not easily performed in a battery, and consequently, the discharge capacity tends to lower. On the other hand, when the average particle diameter of the crystallized glass powder is less than 0.01 μm, the density of the resultant electrode lowers in a battery, and hence the capacity per unit volume of the battery tends to lower. Further, when an electrode paste is produced, the crystallized glass powder tends to be difficult to disperse in a solvent easily. Note that the average particle diameter D₅₀ of the crystallized glass powder in the present invention refers to a value obtained by measurement in accordance with laser diffractometry.

As already described, the positive electrode material for a lithium ion secondary battery according to the first embodiment is produced by modifying the surface of the crystallized glass powder, and hence the elevation of the internal resistance of a battery can be suppressed when a large electric current flows at the time of discharge, thus being able to suppress the reduction in output voltage. Specifically, the positive electrode material for a lithium ion secondary battery according to the first embodiment of the present invention has an average output voltage of preferably 2.5 V or more, 2.6 V or more, particularly preferably 2.7 V or more at the time of discharge at a 10 C rate.

Further, the positive electrode material for a lithium ion secondary battery according to the first embodiment has a discharge capacity of preferably 15 mAhg⁻¹ or more, 20 mAhg⁻¹ or more, particularly preferably 25 mAhg⁻¹ or more at a 10 C rate.

Further, the electric conductivity of the positive electrode material for a lithium ion secondary battery according to the first embodiment is 1.0×10⁻⁸ S·cm^{—1} or more, preferably 2.0×10⁻⁸ S·cm⁻¹ or more, more preferably 1.0×10⁻⁷ S·cm⁻¹ or more.

Next, a method of producing the positive electrode material for a lithium ion secondary battery according to the first embodiment is described.

First, powders of raw materials are blended so as to have the above-mentioned composition. The resultant powders of raw materials are subjected to a melting and quenching process, a sol-gel process, a chemical vapor deposition process such as spraying solution mist into a flame, a mechanochemical process, or the like, providing crystallizable glass as a precursor. Any of these processes facilitates the promotion of vitrification, and as a result, an amorphous layer is likely to be formed on the surface of crystallized glass.

The resultant crystallizable glass is subjected to heat treatment, providing crystallized glass. Here, it is possible that, after bulk crystallized glass is subjected to heat treatment, providing crystallized glass, the crystallized glass is pulverized into a crystallized glass powder. Alternatively, it is possible that crystallizable glass is pulverized, followed by heat treatment, providing a crystallized glass powder. The heat treatment of crystallizable glass is carried out in, for example, an electric furnace in which a temperature and an atmosphere can be controlled.

A heat treatment temperature is not particularly limited because it varies depending on the compositions of crystallizable glass and the desired sizes of a crystallite, but it is suitable to carry out heat treatment at least at the glass transition temperature, preferably at a temperature equal to or higher than the crystallization temperature (specifically, 500° C. or more, preferably 550° C. or more). When heat treatment is carried out at a temperature lower than the glass transition temperature, a crystal precipitates insufficiently, with the result that the discharge capacity may lower. On the other hand, the upper limit of the heat treatment temperature is preferably 900° C., particularly preferably 850° C. When the heat treatment temperature is more than 900° C., a different kind of crystal is liable to precipitate, and consequently, the lithium ion conductivity may lower.

A heat treatment time can be appropriately adjusted so as for the crystallization of crystallizable glass to progress sufficiently. Specifically, the heat treatment time is preferably 10 to 180 minutes, particularly preferably 20 to 120 minutes.

It is preferred that, when heat treatment is carried out, a conduction active material such as carbon or an organic compound be added to a crystallizable glass powder, and the whole be fired under an inert or reductive atmosphere. The method facilitates the formation of an amorphous layer in the surface of a crystallized glass powder. Further, the amorphous layer can contain a C component, thereby being able to improve the electron conductivity of the amorphous layer. Further, the conduction active material such as carbon or an organic compound exhibits a reductive action by being fired, and hence the valence of iron in glass is likely to change to a divalence when glass crystallization takes place, thus being able to yield an olivine-type LiMₓFe₁₋ₓPO₄ crystal selectively at a high ratio.

The addition amount of the conduction active material is preferably 0.1 to 50 parts by mass, 1 to 30 parts by mass, particularly preferably 5 to 20 parts by mass with respect to 100 parts by mass of the crystallizable glass. When the addition amount of the conduction active material is less than 0.1 part by mass, it is difficult for the effect of improving the electron conductivity of the amorphous layer to be sufficiently provided. When the addition amount of the conduction active material is more than 50 parts by mass, a potential difference between a positive electrode and a negative electrode in a lithium ion secondary battery becomes smaller, and as a result, a desired electromotive force may not be provided to the battery.

Next, the positive electrode material for a lithium ion secondary battery according to a second embodiment of the present invention is described. In the positive electrode material for a lithium ion secondary battery according to the second embodiment, the content of a magnetic particle is preferably 1,000 ppm or less, 700 ppm or less, particularly preferably 500 ppm or less. When the content of a magnetic particle is more than 1,000 ppm, the magnetic particle is dissolved in an electrolytic solution to produce a dendrite in repeatedly charging and discharging a battery, and hence a short circuit is caused in the battery, with the result that the battery performance may be impaired. Moreover, the battery may be overheated and ignites in some cases.

Examples of the magnetic particle include metal iron and iron phosphide particles. The average particle diameter of the magnetic particle is generally about 10 to 500 μm, particularly about 20 to 300 μm.

When the positive electrode material for a lithium ion secondary battery is formed of crystallized glass, the content of the magnetic particle in the positive electrode material is likely to reduce. Specifically, it is preferred that the positive electrode material be formed of crystallized glass including, as a composition expressed in terms of mol %, 20 to 50% of Li₂O, 5 to 40% of Fe₂O₃, and 20 to 50% of P₂O₅. The reason why the composition was limited to that mentioned above is described below.

Li₂O is a main component of an LiMₓFe₁₋ₓPO₄ crystal. The content of Li₂O is 20 to 50%, preferably 25 to 45%. When the content of Li₂O is less than 20% or more than 50%, the LiMₓFe₁₋ₓPO₄ crystal is difficult to precipitate.

Fe₂O₃ is also a main component of an LiMₓFe₁₋ₓPO₄ crystal. The content of Fe₂O₃ is preferably 10 to 40%, 15 to 35%, 25 to 35%, particularly preferably 31.6 to 34%. When the content of Fe₂O₃ is less than 10%, the LiMₓFe₁₋ₓPO₄ crystal is difficult to precipitate. When the content of Fe₂O₃ is more than 40%, the LiMₓFe₁₋ₓPO₄ crystal is difficult to precipitate and an undesirable Fe₂O₃ crystal is liable to precipitate. The Fe₂O₃ crystal is reduced in the later step, which causes a magnetic particle to be generated.

P₂O₅ is a main component of an LiMₓFe₁₋ₓPO₄ crystal. The content of P₂O₅ is 20 to 50%, preferably 25 to 45%. When the content of P₂O₅ is less than 20% or more than 50%, the LiMₓFe₁₋ₓPO₄ crystal is difficult to precipitate.

Further, in addition to the above-mentioned components, it is permissible to add, as components for improving the glass-forming ability, for example, Nb₂O₅, V₂O₅, SiO₂, B₂O₃, GeO₂, Al₂O₃, Ga₂O₃, Sb₂O₃, and Bi₂O₃. The total content of these components is preferably 0.1 to 25%. When the total content of these components is less than 0.1%, vitrification tends to be difficult. When the total content is more than 25%, the ratio of the LiMₓFe₁₋ₓPO₄ crystal may lower.

Of those, Nb₂O₅ is a component effective for providing homogeneous glass. The content of Nb₂O₅ is preferably 0.1 to 20%, 1 to 10%, particularly preferably 4 to 6.3%. When the content of Nb₂O₅ is less than 0.1%, homogeneous glass is difficult to be provided. On the other hand, when the content of Nb₂O₅ is more than 20%, a different kind of crystal such as an iron niobate crystal precipitates at the time of glass crystallization, and consequently, the charge and discharge characteristics of a battery using the resultant glass tend to lower.

The positive electrode material for a lithium ion secondary battery according to the second embodiment has a discharge capacity of preferably 15 mAhg⁻¹ or more, 20 mAhg⁻¹ or more, particularly preferably 25 mAhg⁻¹ or more at a 10 C rate.

Further, the positive electrode material for a lithium ion secondary battery according to the second embodiment has an average output voltage of preferably 2.5 V or more, 2.6 V or more, particularly preferably 2.7 V or more at the time of discharge at a 10 C rate.

The discharge capacity and the average output voltage at a 10 C rate can be accomplished by limiting the content of Fe₂O₃ or Nb₂O₅ to that described above.

The content of the LiMₓFe₁₋ₓPO₄ crystal in the crystallized glass forming the positive electrode material for a secondary battery according to the second embodiment is preferably 20 mass % or more, 50 mass % or more, 70 mass % or more. When the content of the LiMₓFe₁₋ₓPO₄ crystal is less than 20 mass %, the conductivity tends to be insufficient. Note that though the upper limit of the content is not particularly limited, the content is realistically 99 mass % or less, more realistically 95 mass % or less.

The positive electrode material for a secondary battery according to the second embodiment is produced by, for example, blending powders of raw materials so as to have the above-mentioned composition, melting the resultant powders of raw materials to yield crystallizable glass as a precursor, and then carrying out crystallization treatment by heating. Here, the crystallizable glass is preferably produced by a melting and quenching method. The melting and quenching method facilitates the promotion of vitrification and inhibits the occurrence of an unreacted iron raw material, and as a result, a positive electrode material having a small content of a magnetic particle is likely to be provided. Further, a melting temperature is preferably adjusted in the range of 1,200 to 1,400° C. When the melting temperature is adjusted in the range, the occurrence of an unreacted iron raw material is inhibited, and a positive electrode material having a small content of a magnetic particle is likely to be provided.

It is also possible that the resultant precursor crystallizable glass is pulverized into a crystallizable glass powder, and then the crystallizable glass powder is subjected to, for example, heat treatment in an electric furnace in which a temperature and an atmosphere can be controlled, thereby yielding a positive electrode material formed of a crystallized glass powder. The temperature history of the heat treatment is not particularly limited because it varies depending on the compositions of crystallizable glass and the desired sizes of a crystallite, but it is suitable to carry out the heat treatment at least at the glass transition temperature and preferably at a temperature equal to or higher than the crystallization temperature. The upper limit temperature of the heat treatment is preferably 1,000° C., more preferably 950° C. When the heat treatment is carried out at a temperature lower than the glass transition temperature, a crystal precipitates insufficiently, and consequently, the effect of improving conductivity may not be provided sufficiently. On the other hand, when the heat treatment is carried out at a temperature higher than 1,000° C., a crystal may melt. The specific temperature range of the heat treatment is preferably 500 to 1,000° C., particularly preferably 550 to 950° C. A heat treatment time can be appropriately adjusted so as for the crystallization of precursor glass to progress sufficiently. Specifically, the heat treatment time is preferably 10 to 180 minutes, particularly preferably 20 to 120 minutes.

At this time, it is preferred that, when heat treatment is carried out, a conduction active material such as carbon or an organic compound be added to crystallizable glass powder, and the whole be fired under an inert or reductive atmosphere. Carbon or an organic compound exhibits a reductive action by being fired, and hence the valence of iron in glass is likely to change to a divalence before glass crystallization takes place, thus being able to yield LiMₓFe₁₋ₓPO₄ at a high content.

The addition amount of the conduction active material is preferably 0.1 to 50 parts by mass, 1 to 30 parts by mass, particularly preferably 5 to 20 parts by mass with respect to 100 parts by mass of the crystallizable glass powder. When the addition amount of the conduction active material is less than 0.1 part by mass, it is difficult for the effect of imparting conductivity to be sufficiently provided. When the addition amount of the conduction active material is more than 50 parts by mass, a potential difference between a positive electrode and a negative electrode in a lithium ion secondary battery becomes smaller, and as a result, a desired electromotive force may not be provided to the battery.

The average particle diameter of the crystallized glass powder is preferably smaller because the whole surface area of the resultant positive electrode material becomes larger, and as a result, exchanges of ions and electrons are easily performed. Specifically, the average particle diameter of the crystallized glass powder is preferably 50 μm or less, 30 μm or less, particularly preferably 20 μm or less. The lower limit of the average particle diameter is not particularly limited, but the average particle diameter is realistically 0.05 μm or more.

The crystallizable glass powder or crystallized glass powder is subjected to sieve classification if necessary. Here, when a sieve made of a metal such as stainless steel is used, the powder may be contaminated with an iron compound as an impurity, and hence a non-metal sieve such as a plastic sieve is preferably used.

As the size of a crystallite in the LiMₓFe₁₋ₓPO₄ crystal in the crystallized glass powder is smaller, it is possible to make the particle diameter of the crystallized glass powder smaller, and the electric conductivity can be improved. Specifically, the size of a crystallite is preferably 100 nm or less, more preferably 80 nm or less. The lower limit of the size is not particularly limited, but the size is realistically 1 nm or more, more realistically 10 nm or more. Note that the size of a crystallite is determined according to the Scherrer's equation based on the results of the powder X-ray diffraction analysis of the crystallized glass powder.

The electric conductivity of the positive electrode material for a lithium ion secondary battery according to the second embodiment is 1.0×10⁻⁸ S·cm⁻¹ or more, preferably 1.0×10⁻⁶ S·cm⁻¹ or more, more preferably 1.0×10⁻⁴ S·cm⁻¹ or more.

### EXAMPLES

Hereinafter, the present invention is described in detail based on examples, but the present invention is not limited to the examples.

### Example 1

Lithium metaphosphate (LiPO₃), lithium carbonate (Li₂CO₃), ferric oxide (Fe₂O₃), and niobium oxide (Nb₂O₅) were used as raw materials, and powders of the raw materials were blended so as to have 33.0% of Li₂O, 31.7% of Fe₂O₃, 31.2% of P₂O₅, and 4.1% of Nb₂O₅ as a composition expressed in terms of mol %. The powders were melted at 1,250° C. for 1 hour in an air atmosphere. After that, the molten glass was poured into a pair of rolls and formed into a film shape while being quenched, thus producing crystallizable glass as a precursor.

After that, the crystallizable glass was pulverized with a ball mill, and a slurry was prepared by mixing 18 parts by mass (corresponding to 12.4 parts by mass in terms of graphite) of a phenol resin and 42 parts by mass of ethanol as a solvent with respect to 100 parts by mass of the resultant crystallizable glass powder. Then, the slurry was formed into a sheet shape having a thickness of 500 μm by a known doctor blade method, followed by drying at 80° C. for about 1 hour. Next, the resultant sheet-like formed body was cut into pieces each having a predetermined size and the pieces were subjected to heat treatment in a nitrogen atmosphere at 800° C. for 30 minutes to perform crystallization, thereby yielding a positive electrode material (sintered body of the crystallized glass powder). When a powder X-ray diffraction pattern was checked, a diffraction line derived from LiFePO₄ was confirmed.

A transmission electron microscope was used to observe the cross-section of the crystallized glass powder. The resultant image confirmed that the crystallized glass powder had an amorphous layer with a thickness of 15 nm in its surface. Further, the ratio of the amorphous layer in the surface of the crystallized glass powder was 60%. The amorphous layer was measured for its composition with EDX. As a result, the amorphous layer was found to have 9% of P, 2% of Fe, 3% of Nb, 55% of O, and 31% of C as a composition expressed in terms of atom %.

Further, the resultant positive electrode material had a discharge capacity of 28 mAhg⁻¹ and an average output voltage of 2.8 V at a 10 C rate.

Note that the discharge capacity and the average output voltage at a 10 C rate were evaluated in the following manner.

The positive electrode material, polyvinylidene fluoride as a binder, and ketjen black as a conductive material were weighed at the ratio of “positive electrode material:binder:conductive material=85:10:5” (mass ratio), and these were dispersed in N-methylpyrrolidone (NMP), followed by sufficient stirring with a rotation-revolution mixer, yielding a slurry. Next, a doctor blade with an gap of 150 μm was used to coat the resultant slurry on an aluminum foil having a thickness of 20 μm which is a positive electrode current collector, and the coated aluminum foil was dried at 80° C. with a dryer, was then passed through a pair of rotating rollers, and was pressed at 1 t/cm², yielding an electrode sheet. An electrode punching machine was used to punch out the electrode sheet to make pieces each having a diameter of 11 mm, followed by drying at 140° C. for 6 hours, yielding circular working electrodes.

Next, one of the resultant working electrodes was placed with its aluminum foil surface facing downward on a lower lid of a coin cell, and there were laminated, on the working electrode, a separator formed of a polypropylene porous film (Celgard #2400 manufactured by Hoechst Celanese Corporation) having a diameter of 16 mm prepared by drying under reduced pressure at 60° C. for 8 hours, and metal lithium serving as the opposite electrode, thus producing a test battery. Used as an electrolytic solution was a 1 M LiPF₆ solution/ethylene carbonate (EC):diethyl carbonate (DEC)=1:1. Note that the assembly of the test battery was carried out in an environment of a dew-point temperature of −60° C. or less.

A charge-discharge test was carried out in the following manner. Charge (release of lithium ions from a positive electrode material) was carried out by constant current (CC) charge from 2 V until 4.2 V. Discharge (storage of lithium ions in a positive electrode material) was carried out by discharge from 4.2 V until 2 V.

### Comparative Example 1

Lithium carbonate, ferrous oxalate dihydrate, and ammonium phosphate dibasic were used as raw materials, and powders of the raw materials were blended at a molar ratio of 33.3% of Li₂O, 33.3% of Fe₂O₃, and 33.3% of P₂O₅. The powders were fired at 800° C. for 48 hours in a nitrogen atmosphere, yielding a crystal powder.

A slurry was prepared by mixing 18 parts by mass (corresponding to 12.4 parts by mass in terms of graphite) of a phenol resin and 42 parts by mass of ethanol as a solvent with respect to 100 parts by mass of the resultant crystal powder. Then, the slurry was formed into a sheet shape having a thickness of 500 μm by a known doctor blade method, followed by drying at 80° C. for about 1 hour. Next, this sheet material was cut into pieces each having a predetermined size and the pieces were subjected to heat treatment in nitrogen at 800° C. for 30 minutes, thereby yielding a positive electrode material powder. When a powder X-ray diffraction pattern was checked, a diffraction line derived from LiFePO₄ was confirmed.

A transmission electron microscope was used to observe the cross-section of the positive electrode material powder, but no amorphous layer was confirmed in the surface of the powder.

The resultant positive electrode material had a discharge capacity of almost 0 mAhg⁻¹ at a 10 C rate, and the average output voltage was not able to be measured because of too large internal resistance.

### Example 2

Lithium metaphosphate (LiPO₃), lithium carbonate (Li₂CO₃), ferric oxide (Fe₂O₃), and niobium oxide (Nb₂O₅) were used as raw materials, and powders of the raw materials were blended so as to have 31.7% of Li₂O, 31.7% of Fe₂O₃, 31.7% of P₂O₅, and 4.8% of Nb₂O₅ as a composition expressed in terms of mol %. The powders were melted at 1,200° C. for 1 hour in an air atmosphere. After that, the molten glass was poured into a pair of rolls and formed into a film shape while being quenched, thus producing a crystallizable glass sample as a precursor.

After that, the crystallizable glass sample was pulverized with a ball mill, and a slurry was prepared by mixing 30 parts by mass (corresponding to 18.9 parts by mass in terms of graphite) of an acrylic resin (polyalkyl methacrylate), 3 parts by mass of butyl benzyl phthalate as a plasticizer, and 35 parts by mass of methyl ethyl ketone as a solvent with respect to 100 parts by mass of the resultant crystallizable glass powder. Then, the slurry was formed into a sheet shape having a thickness of 200 μm by a known doctor blade method, followed by drying at room temperature for about 2 hours. Next, the resultant sheet-like formed body was cut into pieces each having a predetermined size and the pieces were subjected to heat treatment in a nitrogen atmosphere at 800° C. for 30 minutes, thereby yielding a positive electrode material. When a powder X-ray diffraction pattern was checked, a diffraction line derived from LiFePO₄ was confirmed.

When the content of a magnetic particle in the resultant positive electrode material was measured, the result was 0 ppm (not detected). Note that the content of a magnetic particle was evaluated by measuring the amount of a magnetic particle attaching to a magnet having a magnetic flux density of 300 mT when the magnet was brought into contact with 100 g of a powdered positive electrode material produced by pulverization.

Further, the resultant positive electrode material had a discharge capacity of 28 mAhg⁻¹ and an average output voltage of 2.8 V at a 10 C rate.

The discharge capacity and the average output voltage at a 10 C rate were evaluated in the following manner.

The positive electrode material, polyvinylidene fluoride as a binder, and ketjen black as a conductive material were weighed at the ratio of “positive electrode material:binder:conductive material=85:10:5” (mass ratio), and these were dispersed in N-methylpyrrolidone (NMP), followed by sufficient stirring with a rotation-revolution mixer, yielding a slurry. Next, a doctor blade with an gap of 150 μm was used to coat the resultant slurry on an aluminum foil having a thickness of 20 μm which is a positive electrode current collector, and the coated aluminum foil was dried at 80° C. with a dryer, was then passed through a pair of rotating rollers, and was pressed at 1 t/cm², yielding an electrode sheet. An electrode punching machine was used to punch out the electrode sheet to make pieces each having a diameter of 11 mm, followed by drying at 140° C. for 6 hours, yielding circular working electrodes.

Next, one of the resultant working electrodes was placed with its copper foil surface facing downward on a lower lid of a coin cell, and there were laminated, on the working electrode, a separator formed of a polypropylene porous film (Celgard #2400 manufactured by Hoechst Celanese Corporation) having a diameter of 16 mm prepared by drying under reduced pressure at 60° C. for 8 hours, and metal lithium serving as the opposite electrode, thus producing a test battery. Used as an electrolytic solution was a 1 M LiPF₆ solution/ethylene carbonate (EC):diethyl carbonate (DEC)=1:1. Note that the assembly of the test battery was carried out in an environment of a dew-point temperature of −60° C. or less.

A charge-discharge test was carried out in the following manner. Charge (release of lithium ions from a positive electrode material) was carried out by constant current (CC) charge from 2 V until 4.2 V. Discharge (storage of lithium ions in a positive electrode material) was carried out by discharge from 4.2 V until 2 V.

### Comparative Example 2

Lithium carbonate, ferrous oxalate dihydrate, and ammonium phosphate dibasic were used as raw materials, and powders of the raw materials were blended at a molar ratio of 33.3% of Li₂O, 33.3% of Fe₂O₃, and 33.3% of P₂O₅. The powders were fired at 800° C. for 48 hours in a nitrogen atmosphere, yielding a crystal powder.

A slurry was prepared by mixing 30 parts by mass (corresponding to 18.9 parts by mass in terms of graphite) of an acrylic resin (polyalkyl methacrylate), 3 parts by mass of butyl benzyl phthalate as a plasticizer, and 35 parts by mass of methyl ethyl ketone as a solvent with respect to 100 parts by mass of the resultant crystal powder. Then, the slurry was formed into a sheet shape having a thickness of 200 μm by a known doctor blade method, followed by drying at room temperature for about 2 hours. Next, this sheet material was cut into pieces each having a predetermined size and the pieces were subjected to heat treatment in nitrogen at 800° C. for 30 minutes, thereby yielding a positive electrode material. When a powder X-ray diffraction pattern was checked, a diffraction line derived from LiFePO₄ was confirmed.

When the content of a magnetic particle in the resultant positive electrode material was measured, the result was 1,300 ppm.

### INDUSTRIAL APPLICABILITY

The positive electrode material for a lithium ion secondary battery of the present invention is suitable for portable electronic devices such as notebook computers and portable phones, electric vehicles, and the like.

1. A positive electrode material for a lithium ion secondary battery, comprising a crystallized glass powder comprising an olivine-type crystal represented by General Formula LiMₓFe₁₋ₓPO₄ where a relationship of 0≦x<1 is established and M represents at least one kind selected from Nb, Ti, V, Cr, Mn, Co, and Ni, wherein the crystallized glass powder has an amorphous layer in its surface.

2. The positive electrode material for a lithium ion secondary battery according to claim 1, wherein the crystallized glass powder comprises, as a composition expressed in terms of mol %, 20 to 50% of Li₂O, 5 to 40% of Fe₂O₃, and 20 to 50% of P₂O₅.

3. The positive electrode material for a lithium ion secondary battery according to claim 2, wherein the crystallized glass powder further comprises, as a composition expressed in terms of mol %, 0.1 to 25% of Nb₂O₅+V₂O₅+SiO₂+B₂O₃+GeO₂+Al₂O₃+Ga₂O₃+Sb₂O₃+Bi₂O₃.

4. The positive electrode material for a lithium ion secondary battery according to claim 1, wherein the amorphous layer comprises, as a composition expressed in terms of atom %, 5 to 40% of P, 0 to 25% of Fe+Nb+Ti+V+Cr+Mn+Co+Ni, 0 to 60% of C, and 30 to 80% of O.

5. The positive electrode material for a lithium ion secondary battery according to claim 1, wherein the crystallized glass powder has an average particle diameter of 0.01 to 20 μm.

6. The positive electrode material for a lithium ion secondary battery according to claim 1, which has an average output voltage of 2.5 V or more at a time of discharge at a 10 C rate.

7. The positive electrode material for a lithium ion secondary battery according to claim 1, wherein which has a discharge capacity of 15 mAhg⁻¹ or more at a 10 C rate.

8. A lithium ion secondary battery, using the positive electrode material for a lithium ion secondary battery according to claim 1.

9. A positive electrode material for a lithium ion secondary battery, comprising an olivine-type crystal represented by General Formula LiMₓFe₁₋ₓPO₄ where a relationship of 0≦x<1 is established and M represents at least one kind selected from Nb, Ti, V, Cr, Mn, Co, and Ni, wherein the positive electrode material comprises a magnetic particle at 1000 ppm or less.

10. The positive electrode material for a lithium ion secondary battery according to claim 9, comprising a crystallized glass comprising, as a composition expressed in terms of mol %, 20 to 50% of Li₂O, 5 to 40% of Fe₂O₃, and 20 to 50% of P₂O₅.

11. The positive electrode material for a lithium ion secondary battery according to claim 10, further comprising, as a composition expressed in terms of mol %, 0.1 to 25% of Nb₂O₅+V₂O₅+SiO₂+B₂O₃+GeO₂+Al₂O₃+Ga₂O₃+Sb₂O₃+Bi₂O₃.

12. The positive electrode material for a lithium ion secondary battery according to claim 9, which has a discharge capacity of 15 mAhg⁻¹ or more at a 10 C rate.

13. The positive electrode material for a lithium ion secondary battery according to claim 9, which has an average output voltage of 2.5 V or more at a time of discharge at a 10 C rate.

14. A lithium ion secondary battery, using the positive electrode material for a lithium ion secondary battery according to claim 9.
